(19) United States
(12) Patent Application Publication
(10) Pub. No.: US 2022/0186548 A1
(43) Pub. Date: Jun. 16, 2022

(54) SPACER FOR INSULATED GLAZING

(71) Applicant: SAINT-GOBAIN GLASS FRANCE, Courbevoie (FR)

(72) Inventors: Bianca BERGS, GANGELT (DE); Walter SCHREIBER, AACHEN (DE); Matthias BACH, LANGRICKENBACH (CH)

(21) Appl. No.: 17/601,213

(22) PCT Filed: Mar. 5, 2020
(86) PCT No.: PCT/EP2020/055834

§ 371 Date: Oct. 4, 2021

(30) Foreign Application Priority Data
Apr. 3, 2019 (EP) 19166929.0

(51) Int. Cl. E06B 3/663; E06B 3/673

(52) U.S. Cl. CPC E06B 3/66323; E06B 3/66333; E06B 3/66361; E06B 3/67321; E06B 2003/66338; E06B 3/66352

(57) ABSTRACT

A spacer for multipane insulated glazings, includes a polymeric main body, including two pane contact surfaces running parallel to one another, a glazing interior surface, and a base surface, wherein the pane contact surfaces and the base surface are connected to one another directly or via connecting surfaces and an insulating film, which has at least one metallic or ceramic layer and is applied on the polymeric main body, wherein the insulating film covers the base surface and the two pane contact surfaces completely and the glazing interior surface at least partially.

The thermal conductivity of glass is lower by roughly a factor of 2 to 3 than that of concrete or similar building materials. However, since, in most cases, panes are designed significantly thinner than comparable elements made of brick or concrete, buildings frequently lose the greatest share of heat via the external glazing. The increased costs necessary for heating and air-conditioning systems make up a part of the maintenance costs of the building that must not be underestimated. Moreover, as a consequence of more stringent construction regulations, lower carbon dioxide emissions are required.

Insulating glazings are an important approach to a solution for this. Consequently, insulating glazings constitute an increasingly greater part of outward directed glazings. Insulating glazings usually include at least two panes made of glass or polymeric materials. The panes are separated from one another by a gas or vacuum space defined by the spacer. The thermal insulation capacity of insulating glass is significantly higher than single glass and can be even further increased and improved in triple glazings or with special coatings. For example, silver-containing coatings enable reduced transmittance of infrared radiation and thus reduce the heating of a building in the summer. In addition to the important property of thermal insulation, optical and aesthetic features also increasingly play an important role in the field of building glazing.

In addition to the nature and structure of the glass, the other components of an insulating glazing are also of major importance. The seal and especially the spacer have a major influence on the quality of the insulating glazing.

The thermal insulation properties of insulating glazings are quite substantially influenced by the thermal conductivity in the region of the edge seal, in particular of the spacer. In the case of customary spacers made of aluminum, the high thermal conductivity of the metal causes the formation of a thermal bridge at the edge of the glass. This thermal bridge leads, on the one hand, to heat losses in the edge region of the insulating glazing and, on the other, with high humidity and low outside temperatures, to the formation of condensation on the inner pane in the region of the spacer.

To solve these problems, thermally optimized, so-called “warm-edge” systems in which the spacers are made of materials with lower thermal conductivity, such as plastics, are increasingly used.

One challenge when using plastics is the proper sealing of the spacer. Leaks within the spacer can otherwise easily result in a loss of an inert gas between the insulating glazings. In addition to a degraded insulating effect, leaks can also readily lead to the penetration of moisture into the insulating glazing. Condensation formed by moisture between the panes of the insulating glazing quite substantially worsens the optical quality and, in many cases, makes replacement of the entire insulating glazing necessary.

DE 19602455 A1 describes inner strips fora gas-filled multipane insulating glazing with a profile body made of plastic, wherein the surface of the profile body that comes into contact with the gas filling of the insulating glazing is coated with a gas-tight barrier layer by material, such as metal, vapor-deposited in a vacuum. However, such coatings usually have high inherent weight and are costly due to the complex process technology. In addition, an insulating effect that satisfies current requirements cannot be achieved therewith.

WO 2017157637 A1 discloses a spacer strip for a refrigerator glazing having a gas-tight thin coating.

Possible approaches for improving the sealing and an associated reduction in thermal conductivity is [sic] applying an insulating film on the spacer. Common film materials include aluminum or stainless steel, which have good gas-tightness.

For example, WO 2013/104507 A1 discloses a spacer with a polymeric main body and an insulating film. The insulating film contains a polymeric film and at least two metallic or ceramic layers arranged alternatingly with at least one polymeric layer, wherein the outer layers are preferably polymeric layers. The metallic layers have a thickness of less than 1 μm and must be protected by polymeric layers. Otherwise, damage to the metallic layers can easily occur during automated processing of the spacers during assembly of the insulating glazings.

WO 2017/74333 A1 discloses an insulating glazing unit with a spacer with a polymeric main body and an insulating coating or an insulating film.

EP 0852280 A1 discloses a spacer for multipane insulating glazings. The spacer can include a metal foil with a thickness of less than 0.1 mm at the base surface and has a glass fiber content in the plastic of the main body. The outer metal foil is subjected to high mechanical stresses during further processing in the insulating glazing. In particular, when spacers are further processed on automated production lines, the metal foil can be easily damaged and the barrier effect thus degraded.

In prior art systems, the insulating film is usually attached to the spacer in the region of the outer seal, i.e., to the back of the spacer. The pane contact surfaces of the spacer are bonded to the panes by means of a sealant that also provides the seal. However, with the known systems, a sealing problem may occur in the insulating glazing, since only the insulating film in connection with the sealant, e.g., polyisobutylene, can create a diffusion barrier for gas and moisture.

Another disadvantage in the prior art systems is the limited choice of materials. For example, in conventional systems, the material for the main body must also meet ever-increasing optical requirements, since the glazing interior surface of the spacer remain visible in the insulating glazing. Recycled plastics do not meet these optical requirements. The spacers are also usually exposed to sunlight which adversely affects their long-term stability.

The object of the invention consists in providing a spacer for an insulating glazing having improved process reliability during processing, especially for the volume market. The object also consists in optimizing the tightness of warm edge spacers against moisture and gas diffusion. At the same time, the selection of materials to be used for the main body of this type of spacer should be expanded. Furthermore, improved long-term stability should be achieved.

The object of the present invention is accomplished according to the invention by a spacer in accordance with the independent claim 1. Preferred embodiments emerge from the dependent claims. A method for manufacturing a spacer according to the invention, its use according to the invention, and an insulating glazing according to the invention emerge from further independent claims.

As a result of the arrangement according to the invention of the insulating film around the main body, greater process reliability in processing by the customer is achieved, in particular when the insulating film is guided completely around the spacer body. This significantly improves the tightness of the warm edge spacers against moisture and gas diffusion. This is of major importance for the customer and for the service life of the spacers.

At the same time, the insulating film can be used for the optical properties of the spacer such that there are no longer any optical demands on the plastic material for the main body of the spacer. This opens up a variety of new possibilities, such as the use of more economical recycled material for the main body. The spacer has the appearance of the film, which can be colored as desired. The use according to the invention of the insulating film also protects the material of the main body against UV action and reduces the risk of outgassing of additives, such as UV absorbers, thus improving long-term stability.

The spacer according to the invention for multipane insulating glazing comprises at least one polymeric main body and one insulating film. The main body comprises two pane contact surfaces running parallel to one another, a base surface, and a glazing interior surface. The pane contact surfaces and the base surface are connected to one another directly or, alternatively, via connecting surfaces. The preferably two connecting surfaces preferably have an angle of 30° to 60° relative to the pane contact surfaces.

The insulating film has at least one metallic or ceramic layer. The insulating film is applied on the polymeric main body, with the insulating film completely covering the base surface and the two pane contact surfaces and at least partially and preferably completely covering the glazing interior surface. In the case of prior art spacers, in which the insulating film covers at most a part of the pane contact surfaces, when installed in the multipane insulating glazing, there is a transition region wherein the sealant arranged between the spacer and the pane no longer makes contact with the insulating film, but is directly in contact with the pane contact surface. By completely covering the two pane contact surfaces of the spacer with the insulating film according to the invention, this transition region is avoided. As a result, higher process reliability is achieved in the processing and the tightness of the spacer against moisture and gas diffusion is significantly improved.

The insulating film preferably covers at least 80%, more preferably at least 98% of the area of the glazing interior surface of the spacer. In a particularly preferred embodiment, the insulating film completely covers the glazing interior surface. Thus, the main body of the spacer can be visually concealed such that visual requirements for the main body are eliminated. The visual properties of the spacer are determined by the insulating film. This increases the selection of suitable materials for the main body.

When the glazing interior surface is completely covered, the insulating film is guided around the entire main body. This can be implemented such that opposite sides of the insulating film on the main body abut edge to edge or are arranged overlappingly.

An overlapping arrangement is preferred since this requires less precision during assembly than an edge to edge arrangement and the attachment of the insulating film to the main body and complete covering can be ensured more reliably and more stably. The width (bÜ) of the overlapping region in which the insulating film is superimposed over itself, can be, for example, in the range from greater than 0 to 5 mm.

The position of the edge to edge arrangement or the overlapping arrangement on the main body can be selected as required. In a preferred embodiment, the position at which opposite sides of the insulating film abut or are arranged overlappingly is situated on the glazing interior surface or on the base surface of the main body edge, preferably in a central region of the glazing interior surface or of the base surface.

Conventional insulating films can be used. The insulating film is preferably a metal foil or a multilayer film. The multilayer film has at least one metallic or ceramic layer, preferably at least one metallic layer. The multilayer film preferably has at least one polymeric layer and at least one metallic or ceramic layer, preferably at least one metallic layer.

The metallic layer in the insulating film preferably contains or is made of iron, aluminum, silver, copper, gold, chromium, and/or alloys or mixtures thereof, more preferably aluminum, silver, copper, and/or alloys or mixtures thereof. Particularly preferably, the metallic layer contains aluminum. The ceramic layer in the insulating film preferably contains or is made of metal oxides, such as aluminum oxide, silicon oxides, silicon nitrides, or mixtures thereof. Particularly preferably, the ceramic layer contains aluminum oxide or silicon oxides. The optionally and preferably present polymeric layer or plastic layer preferably includes polyethylene terephthalate, ethylene vinyl alcohol, polyvinylidene chloride, polyamides, polyethylene, polypropylene, silicones, acrylonitriles, polyacrylates, polymethacrylates, and/or copolymers or mixtures thereof. The above-mentioned materials for the respective layers applies [sic] for all embodiments of the insulating film described in the application, including carrier, barrier, and thin layers, unless otherwise specified.

The insulating film preferably has gas permeation of less than 0.001 g/(m² h).

Suitable insulating films include, for example, metal foils as described in EP 0852280 A1 and multilayer films, as described in WO 2013/104507 A1 or in WO 2016/046081 A1, to which reference is hereby made.

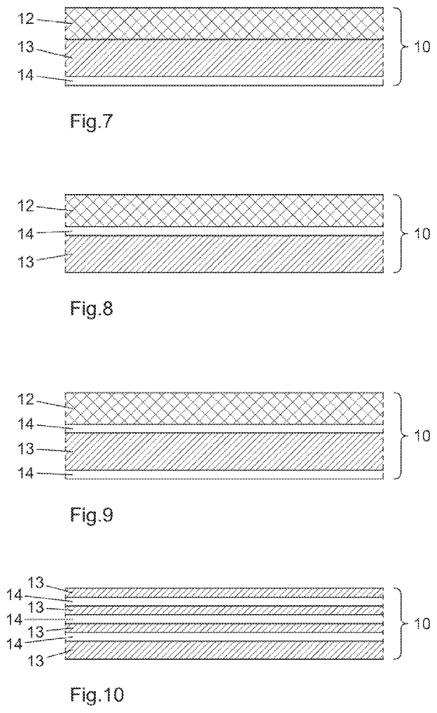

In one embodiment, the multilayer film has at least one metallic barrier layer, at least one, preferably one, polymeric layer and 1, 2, or more metallic or ceramic thin layers. The metallic or ceramic thin layer is preferably a metallic layer. An outer layer is preferably the metallic barrier layer. The metallic or ceramic thin layer is usually adjacent the polymeric layer. The insulating film is preferably attached or bonded to the main body via the metallic barrier layer. However, it is also conceivable for the insulating film to be attached or bonded to the main body with the side opposite the metallic barrier layer. The individual layers can be joined by adhesives. These insulating films are characterized in that multiple metallic foil or ceramic film layers are used in combination with the plastic layers to create tightness and mechanical stability. Examples of this embodiment are shown in FIG. 7 through 9.

The metallic barrier layer preferably has a thickness of 1 μm to 20 μm, more preferably 5 μm to 10 μm, particularly preferably 6 μm to 9 μm. The polymeric layer preferably has a thickness of 5 μm to 80 μm, more preferably of 8 μm to 24 μm, particularly preferably of 10 to 15 μm. In the context of the invention, “a thin layer” refers to a layer with a thickness of less than 100 nm. The at least one metallic or ceramic thin layer preferably has a thickness of 5 nm to 30 nm.

In a preferred embodiment, such an insulating film has the following layer sequence: metallic barrier layer—polymeric layer—metallic or ceramic thin layer. In an alternative embodiment, such an insulating film has the following layer sequence: metallic barrier layer—metallic or ceramic thin layer—polymeric layer. In another preferred embodiment, the insulating film contains at least one second metallic or ceramic thin layer, wherein the following layer sequence is preferred: metallic barrier layer—metallic or ceramic thin layer—polymeric layer—metallic or ceramic thin layer. In all these embodiments, the insulating film is preferably attached on the main body such that the metallic barrier layer faces the main body. Moreover, the metallic or ceramic thin layer is preferably a metallic thin layer.

In an alternative embodiment, the multilayer film has a polymeric carrier layer, at least one other polymeric layer, and at least two metallic or ceramic layers. An outer layer is preferably the polymeric carrier layer. The insulating film is preferably attached or bonded via the polymeric carrier layer. However, it is also conceivable for the insulating film to be attached or bonded to the main body with the side opposite the polymeric carrier layer. The at least two metallic or ceramic layers and the at least one other polymeric layer are usually arranged in an alternating sequence. An example of this embodiment is shown in FIG. 10.

In this multilayer film, there may be, for example, two, three, four, or more metallic or ceramic layers, with all layers being metallic or all layers being ceramic or both at least one metallic layer and at least one ceramic layer. The alternating sequence means that a polymeric layer is arranged between one metallic or ceramic layer and another metallic or ceramic layer. The metallic or ceramic layer is preferably a metallic layer.

The polymeric carrier layer preferably has a thickness of 10 μm to 100 μm. The at least one other polymeric layer preferably has a thickness of 5 μm to 80 μm, more preferably of 10 μm to 80 μm. The at least one metallic or ceramic layer preferably has a thickness of 10 nm to 1500 nm, more preferably of 10 nm to 400 nm, even more preferably of 10 nm to 300 nm, particularly preferably of 10 nm to 200 nm. The metallic or ceramic layer is preferably a metallic or ceramic thin layer, in particular a metallic thin layer, i.e., having a thickness of less than 100 nm.

In a preferred embodiment, the insulating film is opaque. The insulating film can be colored, which can also serve to make the insulating film opaque. The coloring of the insulating film can be done, for example, by adding coloring agents such as pigments in at least one polymeric layer and/or polymeric carrier layer or by an additional color coating. Colored insulating films are commercially available. By means of the coloring, the visual appearance of the spacer can be adapted to desired requirements in a simple manner. This is advantageous since it is no longer necessary for the main body to satisfy visual properties. The insulating film can, for example, be colored black; however, all other colors are, of course, also possible.

To apply the insulating film on the main body, the insulating film is preferably bonded to the main body with an adhesive. The adhesive is preferably a non-gassing adhesive. Examples of suitable adhesives for attaching the insulating film are polyurethane (PU) adhesives, ethyl vinyl acetate copolymer (EVA) adhesives, acrylic adhesives, or epoxy adhesives. Preferred adhesives include hot-melt adhesives, such as PU hot-melt adhesives and EVA hot-melt melt adhesives, or reactive adhesives, such as PU reactive adhesives, acrylic reactive adhesives, or epoxy reactive adhesives. In a preferred variant, the insulating film is bonded to the base surface via a non-gassing polyurethane hot-melt adhesive that cures under moisture.

Alternatively, the insulating film can, for example, be coextruded together with the main body, in order to attach the insulating film to the main body.

In a preferred embodiment, the insulating film is provided with through-holes in the region that is applied on the glazing interior surface, in particular when the main body is completely covered with the insulating film. This is advantageous to enable a gas exchange with the glazing interior, in particular, for drying. The through-holes can be positioned on the glazing interior surface in the overlapping region of the insulating film, if present, or positioned at any other location. If the glazing interior surface is not completely covered with the insulating film, such through-holes are usually not necessary.

The through-holes can be arranged distributed over the glazing interior surface, e.g., when a desiccant is incorporated in the main body. When the main body is implemented with at least one hollow space and openings in the glazing interior surface, it is preferred for the through-holes to be positioned at least partially over the openings of the main body in order to form a common opening that, in the installed state, provide a passage from the hollow space of the main body to the glazing interior of the insulating glazing. The through-holes can be made in the insulating film prior to the attachment of the insulating film or thereafter. It is also conceivable to provide the spacer with the openings in the main body and the through-holes in the insulating film in one step after attachment of the insulating film on a main body.

The main body preferably has, along the glazing interior surface, a width b of 5 mm to 45 mm, particularly preferably 8 mm to 20 mm. The exact width is governed by the dimensions of the insulating glazing and the desired size of the interspace. The main body preferably has, along the pane contact surfaces, a total height g of 5.5 mm to 8 mm, particularly preferably approx. 6.5 mm.

The main body can, for example, be square or rectangular or have a complex geometry. In a preferred embodiment, it has connecting surfaces between the base surface and one or both pane contact surfaces, as described above.

The main body preferably has at least one, preferably one, hollow space for accommodating desiccant. In a preferred embodiment, the polymeric main body has at least one hollow space and is provided with openings in the glazing interior surface. The openings forma passage from the at least one hollow space to the environment.

In a preferred embodiment for a main body that has at least one hollow space and is provided with openings at the glazing interior surface, the insulating film covers the glazing interior surface completely and is provided, in the region that is applied to the glazing interior surface, with through-holes that are positioned at least partially above the openings of the main body in order to form a common opening that, in the installed state, provides a passage from the hollow space of the main body to the glazing interior.

In an alternative embodiment for a main body that has at least one hollow space and is provided with openings at the glazing interior surface, the insulating film does not cover the glazing interior surface completely such that the openings are not covered by the insulating film. In this case, through-holes in the insulating film are not required. The alternative embodiment is less preferred due to the appearance and the more difficult installation of the insulating film.

The polymeric main body is a main body made of plastic. The plastic materials customary for this purpose can be used. The main body preferably contains polyethylene (PE), polycarbonates (PC), polypropylene (PP), polystyrene, polyesters, polyurethanes, polymethyl methacrylates, polyacrylates, polyamides, polyethylene terephthalate (PET), polybutylene terephthalate (PBT), preferably acrylonitrile-butadiene-styrene (ABS), acrylonitrile-styrene-acrylester (ASA), acrylonitrile-butadiene-styrene-polycarbonate (ABS/PC), styrene-acrylonitrile (SAN), PET/PC, PBT/PC, and/or copolymers or mixtures thereof.

The main body is preferably glass fiber reinforced. The coefficient of thermal expansion of the main body can be varied and adapted through the selection of the glass fiber content in the main body. Temperature-induced stresses between the different materials and flaking of the insulating film can be avoided by adapting the coefficient of thermal expansion of the main body and of the insulating film. The main body preferably has a glass fiber content of 20% to 50%, particularly preferably of 30% to 40%. The glass fiber content in the main body simultaneously improves strength and stability.

One advantage of the present invention consists in that the appearance of the spacer can be determined by the insulating film. Consequently, the appearance of the main body is no longer of concern. This enables the use of more economical materials for the main body. It is, for example, possible to use non-colored plastics for the main body. In particular, the invention enables the use of recycled plastics for the main body. Recycled plastics are usually inhomogeneous in appearance, as a result of which their use in conventional spacers is not possible in light of the visual requirements.

In a preferred embodiment of the invention, the polymeric main body contains recycled plastic. Since recycled plastic is less expensive than normal plastic, the main bodies made of recycled plastic can be produced more economically. In addition, a contribution to environmental protection is made. Recycled plastics of the above-mentioned plastics can be used for the main body, with recycled polypropylene (PP), recycled acrylonitrile-butadiene-styrene (ABS), and/or recycled styrene-acrylonitrile (SAN) being particularly preferred. In a preferred embodiment, the polymeric main body contains a recycled plastic as described above and is glass fiber reinforced.

The main body preferably contains a desiccant, preferably silica gels, molecular sieves, CaCl₂, Na₂SO₄, activated carbon, silicates, bentonites, zeolites, and/or mixtures thereof. The desiccant can be incorporated both within a hollow space or within the glass fiber reinforced polymeric man body itself. The desiccant is preferably contained within the hollow space. The desiccant can then be added just before the assembly of the insulating glazing. This ensures particularly high absorption capacity of the desiccant in the finished insulating glazing. The glazing interior surface preferably has openings that allow absorption of moisture in the air by the desiccant contained in the main body.

The invention further includes an insulating glazing, comprising at least two panes, a spacer according to the invention circumferentially arranged between the panes in the edge region of the panes, a sealant, and an outer sealing layer. A first pane contacts the first pane contact surface of the spacer; and a second pane, the second pane contact surface. A sealant is placed between the first pane and the first pane contact surface and between the second pane and the second pane contact surface. A glazing interior that is bounded by the spacer is formed between the to panes. The two pane [sic] protrude beyond the spacer, creating a circumferential edge region that is filled with an outer sealing layer, preferably a plastic sealing compound. The edge space is opposite the inner interpane space and is delimited by the two panes and the spacer.

The sealant for connecting the spacer and the pane serves, on the one hand, to bond the spacer and, on the other, to seal the gap between the spacer and the pane. A particular advantage of the invention consists in that the sealant makes contact exclusively with the insulating film and not with the pane contact surface itself, since the transition region present in the prior art spacers, in which the sealant does not make contact with the insulating film, but, instead, is in direct contact with the side contact surface of the spacer, is not present with the spacers according to the invention. This increases the process reliability during processing and tightness. Suitable sealants contain, for example, butyl rubber, polyisobutylene, polyethylene vinyl alcohol, ethylene vinyl acetate, polyolefin rubber, copolymers, and/or mixtures thereof.

The outer sealing layer is in contact with the insulating film of the spacer according to the invention. The outer sealing layer contains, for example, polymers or silane-modified polymers, particularly preferably polysulfides, silicones, room-temperature-vulcanizing (RTV) silicone rubber, high-temperature-vulcanizing (HTV) silicone rubber, peroxide-vulcanizing silicone rubber, and/or addition-vulcanizing silicone rubber, polyurethanes, butyl rubber, and/or polyacrylates.

The panes preferably have optical transparency of >85%. The panes are formed from glass and/or transparent polymers. Preferred examples are panes of flat glass, float glass, quartz glass, borosilicate glass, soda lime glass, polycarbonate, polymethyl methacrylate, and/or mixtures thereof.

In principle, various geometries of the panes are possible, for example, rectangular, trapezoidal, and rounded geometries. The panes preferably have a thermal protection coating. The thermal protection coating preferably contains silver. In order to be able to exploit energy saving possibilities, the insulating glazing can be filled with a noble gas, preferably argon or krypton, which reduce the heat transfer value in the insulating glazing interpane space.

The invention further includes a method for producing a spacer according to the invention, wherein the insulating film is attached to the polymeric main body, preferably by bonding using an adhesive.

The invention further includes the use of a spacer according to the invention in multiple glazings, preferably in insulating glazings.

In the following, the invention is explained in greater detail with reference to exemplary embodiments. The drawings are purely schematic representations and not to scale. They in no way restrict the invention. They depict:

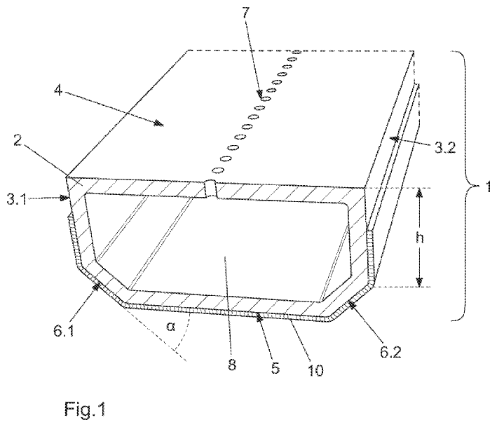

FIG. 1 a cross-section of a prior art spacer,

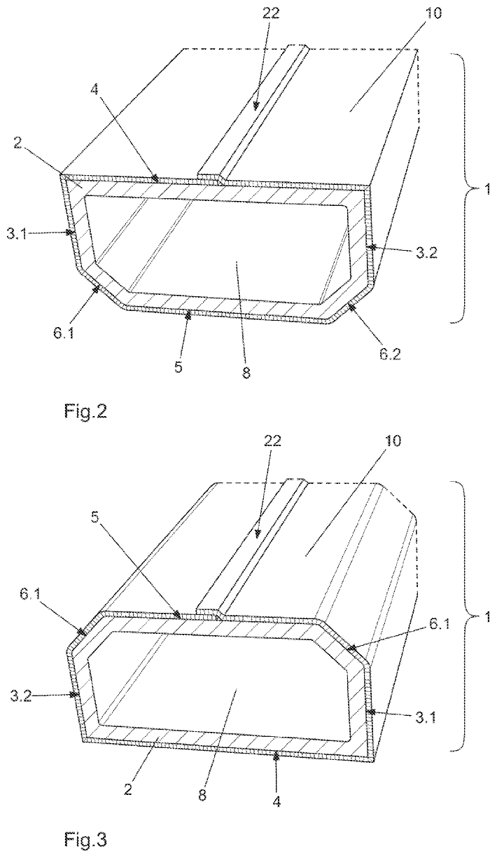

FIG. 2 a cross-section of a spacer according to the invention,

FIG. 3 a cross-section of another spacer according to the invention,

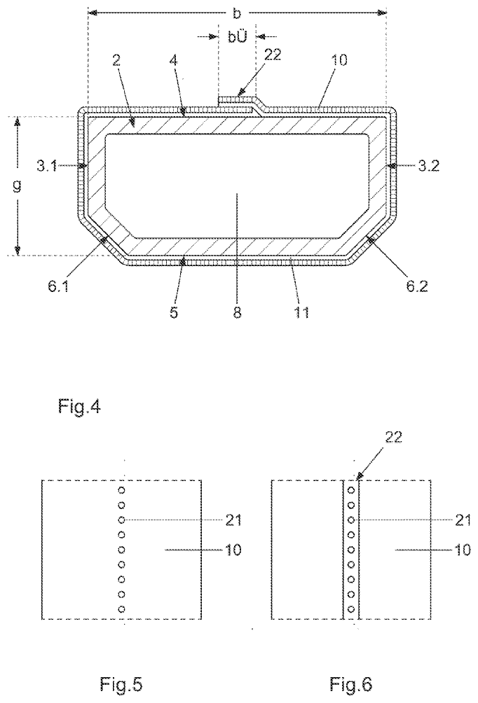

FIG. 4 a cross-section of the spacer according to the invention of FIG. 2 with further details,

FIG. 5 a plan view of the glazing interior surface of a spacer according to the invention provided with insulating film,

FIG. 6 a plan view of the glazing interior surface of another spacer according to the invention provided with insulating film,

FIG. 7 a cross-section of a suitable insulating film,

FIG. 8 a cross-section of another suitable insulating film,

FIG. 9 a cross-section of another suitable insulating film,

FIG. 10 a cross-section of another suitable insulating film, and

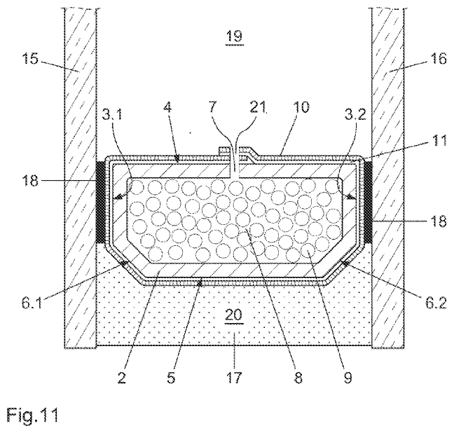

FIG. 11 a cross-section of an insulating glazing according to the invention.

FIG. 1 depicts a cross-section of a prior art spacer 1. The glass fiber reinforced polymeric main body 2 comprises two pane contact surfaces 3.1 and 3.2 running parallel to one another. The pane contact surfaces 3.1 and 3.2 are connected via a base surface 5 and a glazing interior surface 4. Two angled connecting surfaces 6.1 and 6.2 are preferably arranged between the base surface 5 and the pane contact surfaces 3.1 and 3.2. The connecting surfaces 6.1, 6.2 preferably run at an angle α (alpha) of 30° to 60° relative to the base surface 5. The glass fiber reinforced polymeric main body 2 preferably contains styrene acrylonitrile (SAN) and approx. 35 wt.-% of glass fiber. The main body has a hollow space 8. Furthermore, the glazing interior surface 4 is provided with openings 7. The wall thickness of the polymeric main body 2 is, for example, 1 mm. The width b (see FIG. 4) of the main body 2 along the glazing interior surface 4 is, for example, 12 mm. The total height g (see FIG. 4) of the polymeric main body is, for example, 6.5 mm. Applied on the base surface 5 and on a part of the pane contact surfaces 3.1, 3.2 approx. up to half the height h of the pane contact surface is an insulating film 10, which can, for example, be one of the insulating films depicted in FIG. 7 to 10. The insulating film is bonded to the main body with an adhesive (not shown). On the pane contact surfaces, there is a transition region, in which the pane contact surfaces of the main body are not provided with insulating film.

The entire spacer has thermal conductivity of less than 10 W/(m K) and gas permeation of less than 0.001 g/(m² h).

FIG. 2 depicts a cross-section of a spacer 1 according to the invention. The data concerning the spacer of FIG. 1 apply mutatis mutandis, unless otherwise indicated in the following. The spacer according to the invention of FIG. 2 differs from the prior art spacer of FIG. 1 in particular in that the insulating film 10 completely covers the base surface 5, the two pane contact surfaces 3.1, 3.2, and the glazing interior surface 4. The opposite sides of the insulating film 10 are arranged overlappingly in the central region on the glazing interior surface 4, resulting in an overlapping region 22.

The main body 2 is covered by the insulating film 10 such that the appearance of the spacer is determined by the insulating film. The insulating film can be colored and opaque. Consequently, even a main body made of a recycled plastic can be used, since the inhomogeneous appearance of the main body resulting from recycled plastic is irrelevant. For example, a main body made of recycled polypropylene, recycled acrylonitrile-butadiene-styrene, or recycled styrene-acrylonitrile (SAN) can be used. The main body containing recycled plastic is preferably glass fiber reinforced.

FIG. 3 depicts a cross-section of another spacer 1 according to the invention. The spacer corresponds to the spacer of FIG. 2 according to the invention, except for the fact that the overlapping region 22 is implemented in the central region on the base surface 5.

FIG. 4 depicts a cross-section of the spacer of FIG. 2 according to the invention with further details. Depicted here is the fact that the insulating film 10 is attached via an adhesive 11, in this case a polyurethane hot-melt adhesive. The polyurethane hot-melt adhesive bonds the insulating film particularly well to the polymeric main body 2, e.g., when an insulating film per FIG. 7 to 9 is used and is bonded to the main body with the metallic barrier layer 12. The polyurethane hot-melt adhesive is preferably a non-gassing adhesive in order to avoid gases defusing into the glazing interior 19 and causing visible precipitates to form there. The width bÜ of the overlapping region 22 is, for example, greater than 0 to 5 mm.

FIG. 5 depicts a plan view of the glazing interior surface (not visible) provided with insulating film 10 of a spacer according to the invention analogous to FIG. 3. In the variant depicted, the insulating film 10 is provided with through-holes 21 in the central region on the glazing interior surface. The through-holes 21 are in each case positioned above the openings in the glazing interior surface such that a common opening is formed, which, in the installed state, forms a connection between the hollow space of the main body and the glazing interior space of the insulating glazing which serves for gas exchange.

FIG. 6 depicts a plan view of the glazing interior surface (not visible) provided with insulating film 10 of a spacer according to the invention analogous to FIG. 2. In the variant depicted, the insulating film 10 is provided with-through-holes 21 in the overlapping region 22 in the central region on the glazing interior surface. The through-holes 21 are in each case positioned above the openings in the glazing interior surface such that a common opening is formed, which, in the installed state, forms a connection between the hollow space of the main body and the glazing interior space of the insulating glazing, which serves for gas exchange.

FIG. 7 depicts a cross-section of an insulating film 10 that is suitable for the spacer according to the invention. The insulating film 10 is a multilayer film and comprises a metallic barrier layer 12 made of 6-μm-thick aluminum, a polymeric layer 13 made of 12-μm-thick polyethylene terephthalate (PET), and a metallic thin layer 14 made of 10-nm-thick aluminum. The film layers are arranged such that the aluminum layers, i.e., the metallic barrier layer 12 and the metallic thin layer 14 are on the outside. The film is preferably arranged on a polymeric main body according to the invention such that the metallic barrier layer 12 faces the base surface 5. Then, the metallic thin layer 14 faces outward and acts at the same time as an adhesive layer relative to the material of the sealant 18 and the outer sealing layer 17.

FIG. 8 depicts a cross-section of an alternative embodiment of an insulating film 10 that is suitable for the spacer according to the invention. The materials and thicknesses are as described in FIG. 7; however, the order of the individual layers differs. The metallic thin layer 14 lies between the metallic barrier layer 12 and the polymeric layer 13. In this arrangement, the polymeric layer 13 protects the metallic barrier layer 12 against damage.

FIG. 9 depicts a cross-section of another embodiment of an insulating film 10 that is suitable for the spacer according to the invention. The structure of the insulating film 10 is essentially as described in FIG. 8. In addition, a further metallic thin layer 14 is arranged adjacent the polymeric layer 13. This thin layer 14 improves the adhesion to the material of the sealant 18 and the outer sealing layer 17 in the finished insulating glazing.

FIG. 10 depicts a cross-section of another insulating film 10 that is suitable for the spacer according to the invention. The insulating film 10 is a multilayer film and comprises a polymeric carrier layer (13, lowest layer) with a thickness of 12 μm made of LLDPE (linear low density polyethylene), 3 more polymeric layers (13) made of PET (polyethylene terephthalate) with a thickness of 12 μm and 3 metallic layers (14) made of aluminum, each with a thickness of 50 nm. The metallic layers (14) and the polymeric layers (13) are applied alternatingly to the polymeric carrier layer.

FIG. 11 depicts a cross-section of the insulating glazing according to the invention with the spacer 1 according to the invention analogous to FIG. 2 or FIG. 6. Arranged between a first glass pane 15 and a second glass pane 16 is the glass fiber reinforced polymeric main body 2 with the insulating film 10 bonded with an adhesive 11 secured thereon. The insulating film 10 completely covers the base surface 5, the connecting surfaces 6.1, 6.2, the pane contact surfaces 3.1, 3.2, and the glazing interior surface 5. The opposite ends of the insulating film overlap on the glazing interior surface 5.

The first pane 15, the second pane 16, and the insulating film 10 delimit the outer edge space 20 of the glazing, which is filled with the outer sealing layer 17, which contains, for example, polysulfide. Together with the outer sealing layer 17, the insulating film 10 insulates the glazing interior space 19 formed between the panes and the spacer and reduces the heat transfer from the glass fiber reinforced polymeric main body 2 into the glazing interior space 19. The insulating film can be secured on the polymeric main body 2 with PUR hot-melt adhesive, for example.

In the region of the pane contact surfaces 3.1, 3.2, a sealant 18 is arranged between the insulating film 10 and the glass panes 15, 16, e.g., a sealant based on polyisobutylene. The sealant 18 is in contact with the insulating film such that possible interfacial diffusion is prevented. Relative to the spacer, the sealant 18 is in contact only with the insulating film. A transition area that is customary with conventional spacers, in which the sealant is in direct contact with the side contact surface of the spacer, is avoided. Compared to prior art spacers, this results in greater process reliability during processing and significantly improves the tightness of the spacer against moisture and gas diffusion.

The polymeric main body 2 has a central hollow space 8, into which a desiccant 9 is introduced, e.g., molecular sieves. The glazing interior surface 4 includes relatively small openings 7 or pores that enable a gas exchange with the glazing interior space 19. For this purpose, the insulating film is provided with through-holes 21 in the overlapping region, which are positioned above the openings 7, resulting in a common passage.

### LIST OF REFERENCE CHARACTERS

(1) spacer
(2) polymeric main body
(3.1) first pane contact surface
(3.2) second pane contact surface
(4) glazing interior surface
(5) base surface
(6.1) first connecting surface
(6.2) second connecting surface
(7) openings
(8) hollow space
(9) desiccant
(10) insulating film
(11) adhesive
(12) metallic barrier layer
(13) polymeric layer or carrier layer
(14) metallic or ceramic layer or thin layer
(15) first pane
(16) second pane
(17) outer sealing layer
(18) sealant
(19) glazing interior space
(20) outer edge space of the insulating glazing
(21) through-hole of the insulating film
(22) overlapping region of the insulating film
h height of the pane contact surfaces
b width of the polymeric main body along the glazing interior surface
g total height of the main body along the pane contact surfaces
bÜ width of the overlapping region

1. A spacer for multipane insulated glazings, comprising: a polymeric main body, comprising two pane contact surfaces running parallel to one another, a glazing interior surface, and a base surface, wherein the two pane contact surfaces and the base surface are connected to one another directly or via connecting surfaces and an insulating film, which has at least one metallic or ceramic layer and is applied on the polymeric main body, wherein the insulating film covers the base surface and the two pane contact surfaces completely and the glazing interior surface at least partially.

2. The spacer according to claim 1, wherein the insulating film covers at least 80% of an area of the glazing interior surface.

3. The spacer according to claim 1, wherein the insulating film completely covers the glazing interior surface.

4. The spacer according to claim 3, wherein opposite sides of the insulating film abut one another edge to edge or are arranged overlappingly.

5. The spacer according to claim 1, wherein the insulating film is a metal foil or a multilayer films.

6. The spacer according to claim 1, wherein the multilayer film
has at least one metallic barrier layer, at least one polymeric layer, and 1, 2, or more metallic or ceramic thin layers, or
has a polymeric carrier layer, at least one other polymeric layer, and at least two metallic or ceramic layers.

7. The spacer according to claim 1, wherein the insulating film is opaque and/or wherein the insulating film is colored.

8. The spacer according to claim 1, wherein the insulating film is bonded to the polymeric main body via an adhesive.

9. The spacer according to claim 1, wherein the insulating film is provided with through-holes in a region that is applied on the glazing interior surface.

10. The spacer according to claim 1, wherein the polymeric main body has at least one hollow space and is provided with openings in the glazing interior surface, or
the insulating film completely covers the glazing interior surface and is provided with through-holes in the region that is applied on the glazing interior surface that are positioned at least partially above the openings to form a common opening.

11. The spacer according to claim 1, wherein the polymeric main body contains recycled plastic that is recycled polypropylene, recycled acrylonitrile-butadiene-styrene, and/or recycled styrene-acrylonitrile.

12. The spacer according to claim 1, wherein the polymeric main body is glass fiber reinforced.

13. Insulating glazing comprising at least two panes, a spacer according to claim 1 circumferentially arranged between the at least two panes in an edge region of the at least two panes, a sealant, and an outer sealing layer, wherein
a first pane of the at least two panes rests on a first pane contact surface of the two pane contact surfaces,
a second pane rests on a second pane contact surface of the two pane contact surfaces,
the sealant is placed between the first pane and the first pane contact surface and between the second pane and the second pane contact surface, and
the outer sealing layer is placed between the first pane and the second pane in an outer edge space adjacent the insulating film.

14. Method for producing a spacer according to claim 1, comprising placing the insulating film on the polymeric main body.

15. A method comprising installing a spacer according to claim 1 in a multiple glazing.

16. The spacer according to claim 2, wherein the insulating film covers at least 98% of the area of the glazing interior surface.

17. The spacer according to claim 4, wherein opposite sides of the insulating film are arranged overlappingly.

18. The spacer according to claim 5, wherein the multilayer film has at least one polymeric layer and at least one metallic or ceramic layer.

19. The spacer according to claim 6, wherein
when the multilayer film has at least one metallic barrier layer, at least one polymeric layer, and 1, 2, or more metallic or ceramic thin layers, then an outer layer is the metallic barrier layer, and
when the multilayer film has a polymeric carrier layer, at least one other polymeric layer, and at least two metallic or ceramic layers, then an outer layer is the polymeric carrier layer and the at least two metallic or ceramic layers and the at least one other polymeric layer are arranged in an alternating sequence.

20. The spacer according to claim 10, wherein the insulating film does not completely cover the glazing interior surface such that the openings are not covered by the insulating film.
